(19) United States
(12) Patent Application Publication
(10) Pub. No.: US 2017/0299957 A1
(43) Pub. Date: Oct. 19, 2017

(54) Computer-Controlled Array of Image Projectors

(71) Applicant: Microsoft Technology Licensing, LLC, Redmond, WA (US)

(72) Inventors: Andrew D. Wilson, Seattle, WA (US); Evan Shimizu, Pittsburgh, PA (US)

(73) Assignee: Microsoft Technology Licensing, LLC

(21) Appl. No.: 15/130,646

(22) Filed: Apr. 15, 2016

(51) Int. Cl. G03B 21/20; G03B 21/00

(52) U.S. Cl. CPC G03B 21/2053; G03B 21/206; G03B 21/001; G03B 21/2013; G03B 21/202

(57) ABSTRACT

Techniques and architectures involve operating an array of slide projectors having respective brightnesses controlled by a computer. Such an array of slide projectors may be arranged to project their respective images onto a surface so that the respective images substantially overlap with one another on the surface and produce an integrated image. By judicious selection of slides and by judicious control of the brightness of the respective slide projectors, such an integrated image may render a video or an appearance of motion or other dynamic effect.

### BACKGROUND

A video projector generally produces a video or image by projecting the image of an illuminated array of pixels onto a surface. For example, such pixels may be in an array of a liquid crystal display (LCD) or a digital micro-mirror device (DMD). Resolution of video or an image produced by such a video projector may be limited by the resolution of the array of pixels. In some cases, video projectors include a light source and other electrical components that may require cooling fans, which may produce ambient noise.

A slide projector generally produces an image by projecting the image of an analog fixed transparency, such as a photographic slide or negative, onto a surface. A slide projector may be a carousel-type slide projector or a drop-in-type slide projector, for example.

### SUMMARY

This disclosure describes techniques and architectures that involve operating an array of slide projectors having respective brightnesses or intensities controlled by a computer. Such an array of slide projectors may be arranged to project their respective images onto a surface so that the respective images substantially overlap with one another on the surface and produce an integrated image. By judicious selection of slides and by judicious control of the brightness of the respective slide projectors, such an integrated image may render a video or an appearance of motion or other dynamic affect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), quantum devices, such as quantum computers or quantum annealers, and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIG. 1 is a block diagram depicting an environment for operating a system of slide projectors, according to various examples.

FIG. 2 is a schematic diagram of a system of slide projectors producing an image on a surface, according to various examples.

FIG. 3 illustrates an example integrated image.

FIG. 4 illustrates example images that are superimposed to create an integrated image.

FIG. 5 illustrates an example time sequence of the relative brightnesses or intensities of slide projectors that are projecting images of an integrated image.

FIG. 6 is a schematic diagram of an example slide projector.

FIG. 7 is a block diagram of a system of slide projectors operated by a projector control module, according to various examples.

FIG. 8 illustrates a sequence of video frames and a basis of slides selected the sequence, according to various examples.

FIG. 9 is a block diagram illustrating a slide generator module creating a slide, according to various examples.

FIG. 10 is a flow diagram illustrating a process for operating a system of slide projectors, according to some examples.

### DETAILED DESCRIPTION

In various examples, an array of slide projectors of a projection system may be individually oriented to project their respective images onto a surface so that the respective images substantially overlap with one another on the surface and produce an integrated image. For example, each slide projector may be an analog, fixed-image projector that projects an image of a slide (e.g., transparency) by illuminating the slide with a light source and integrating an optical system to project the resulting image onto the surface. A controller connected to each of the slide projectors may vary the brightness of each of the projectors' respective light sources. By coordinating the images of the slides in the slide projectors with the brightness or intensity of each of the slide projectors, the integrated image may be modified discretely or continuously to appear as a video or have other time-changing traits (e.g., image change over time).

For example, such an integrated image produced by a number of slide projectors may be, at any point in time, an instantaneous sum of the same number of fixed images. By modifying respective brightnesses (e.g., intensities) of each of the fixed images, the integrated image may be modified in any of a number of ways. In such a fashion, a finite number (e.g., 3, 5, 10 or so) of fixed-image slides, each generally different from the others, may be used to create a dynamic image such as, for example, a cascading waterfall, a moving star field, falling snow or rain, evolving text or imagery, and other video-type renderings. In other words, a projection system may create a dynamic image from a limited number of static images.

In some examples, slides may be created by decomposing a video sequence (e.g., thousands of frames or images) into a relatively small number of basis images, which may then be projected with varying brightness levels to reconstruct, at least in part, the video sequence. A projection system may project slides at the resolution of the slide itself, thus providing a benefit of relatively high resolution (e.g., 8K resolution). Such a projection system may be used for permanent installations, such as in museums or advertising installations, for art projects, or bright high-resolution static images, just to name a few examples.

In some examples, a non-negative matrix factorization algorithm may be used to create basis images for use in a projection system. The basis images may be normalized so that they can be printed, and the brightness of the projectors having particular basis images may be adjusted accordingly during operation of the projection system.

In some examples, a projection system may comprise a number of off-the-shelf slide projectors of any type (e.g., carousel-type) having a light source modified to be computer controllable (e.g., to be selectively dimmed or brightened). Such slide projectors may be placed in an array or some configuration/orientation so that all the slide projectors project their respective images onto substantially the same area to overlap the projected images. An array of slide projectors may include the slide projectors stacked vertically, horizontally, arranged in a grid, in an arc, or in a circle, just to name a few examples.

In addition to relatively high-resolution image rendering, a projection system as described in some examples herein, may provide benefits such as a relatively low cost solution for projecting high resolution, high brightness, static, or limited movement images. For example, operating such a projection system may be less computationally intensive as compared to operating a video projector that uses pixelated image rendering (e.g., via LCD displays or digital micro-mirror displays). Another benefit may be that such a projection system may provide better color reproduction and contrast using slides as compared to imaging or video produced by video projectors. Slides are generally able to replicate a larger range (or gamut) of color as compared to video projectors. Yet another benefit may be that such a projection system may be quieter than a video projector for at least the reason that the projection system may have less reliability on noisy cooling fans that are typically used in video projectors, for example. Still another benefit may be that such a projection system may provide very high brightness as compared to imaging or video produced by a video projector. For example, in such a projection system having ten projectors, each projector may have a 1000 lumen illumination system so that the projection system as a whole can potentially create a 10,000 lumen image. Maximum brightness may scale with the number of projectors.

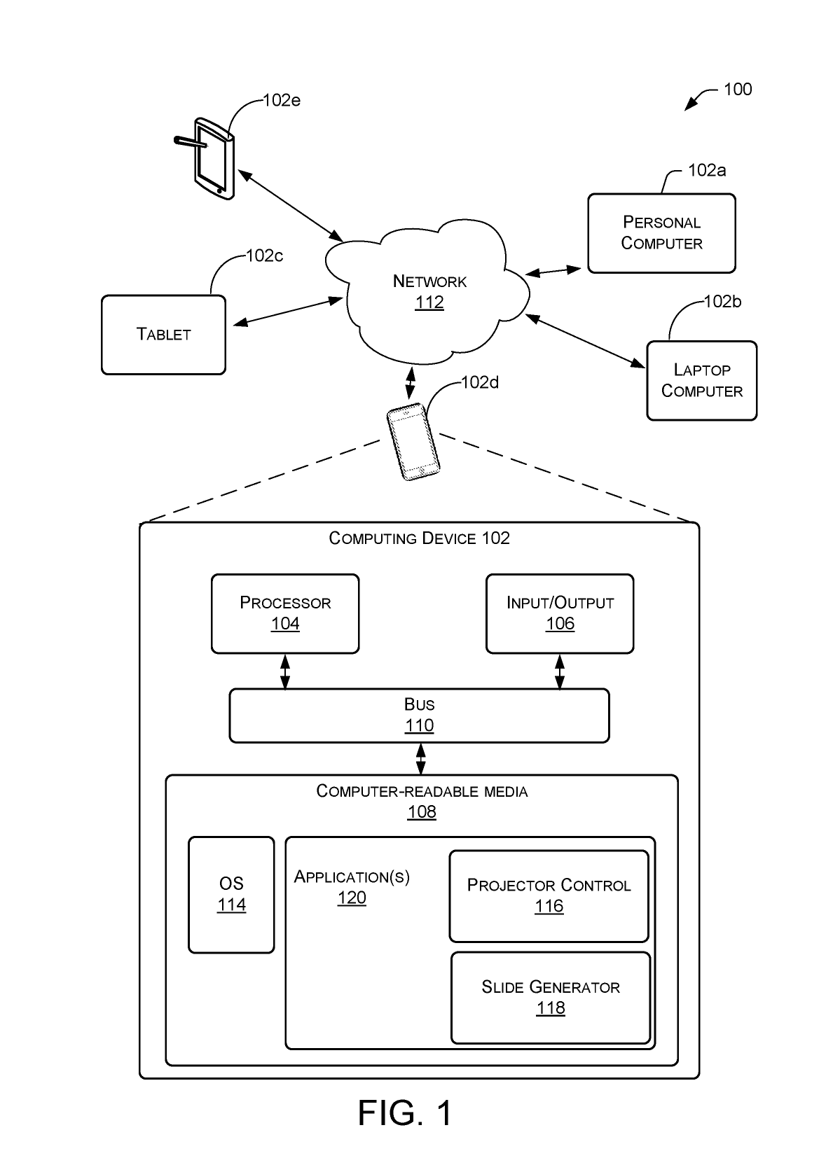

Various examples are described further with reference to FIGS. 1-10.

The environment described below constitutes but one example and is not intended to limit the claims to any one particular operating environment. Other environments may be used without departing from the spirit and scope of the claimed subject matter.

FIG. 1 is a block diagram depicting an environment 100 for, among other things, operating a system of slide projectors, according to various examples. In some implementations, the various devices and/or components of environment 100 include a variety of computing devices 102. By way of example and not limitation, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and computer-readable media (e.g., memory) 108, e.g., via a bus 110. Hereinafter, unless otherwise indicated, the singular “processor” may refer to one or more processors.

Computing devices 102 can include personal computers such as, for example, desktop computers 102a, laptop computers 102b, tablet computers 102c, telecommunication devices 102d, personal digital assistants (PDAs) 102e, electronic book readers, wearable computers, automotive computers, gaming devices, etc. Computing devices 102 can also include business or retail oriented devices such as, for example, server computers, thin clients, terminals, and/or work stations. In some examples, computing devices 102 can include, for example, components for integration in a computing device, appliance, or other sorts of devices.

In some examples, some or all of the functionality described as being performed by computing devices 102 may be implemented by one or more remote peer computing devices, a remote server or servers, or a cloud computing resource, some or all of which may communicate via a network 112, for example.

In some examples, as shown regarding device 102d, computer-readable media 108 can store instructions executable by the processor 104 and may include an operating system (OS) 114, a projector control module 116, a slide generator module 118, and programs or applications 120 that are loadable and executable by processor 104. The processor 104 may include one or more central processing units (CPUs), graphics processing units (GPUs), video buffer processors, and so on. In some implementations, projector control module 116 comprises executable code stored in computer-readable media 108 and is executable by processor 104 to provide electronic signals generated by computing device 102, via input/output 106. The electronic signals may be associated with one or more of applications 120. In some implementations, projector control module 116 and slide generator module 118 may be located in different computer systems (e.g., one or the other module in computing device 102 and the other module in a different computing device).

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, computer-readable media 108 is an example of computer storage media storing computer-executable instructions. When executed by processor 104, the computer-executable instructions configure the processor(s) to, among other things, vary the brightness of a respective light source in individual image projectors. Collectively, such image projectors may be configured to produce analog, non-pixelated images, for example.

In various examples, an input device of input/output (I/O) interfaces 106 can be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106 to allow the computing device 102 to communicate with other devices, which may be on network 112, for example. I/O interfaces 106 can include one or more network interfaces to enable communications between computing device 102 and other networked devices included in network 112. Such other devices may include user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

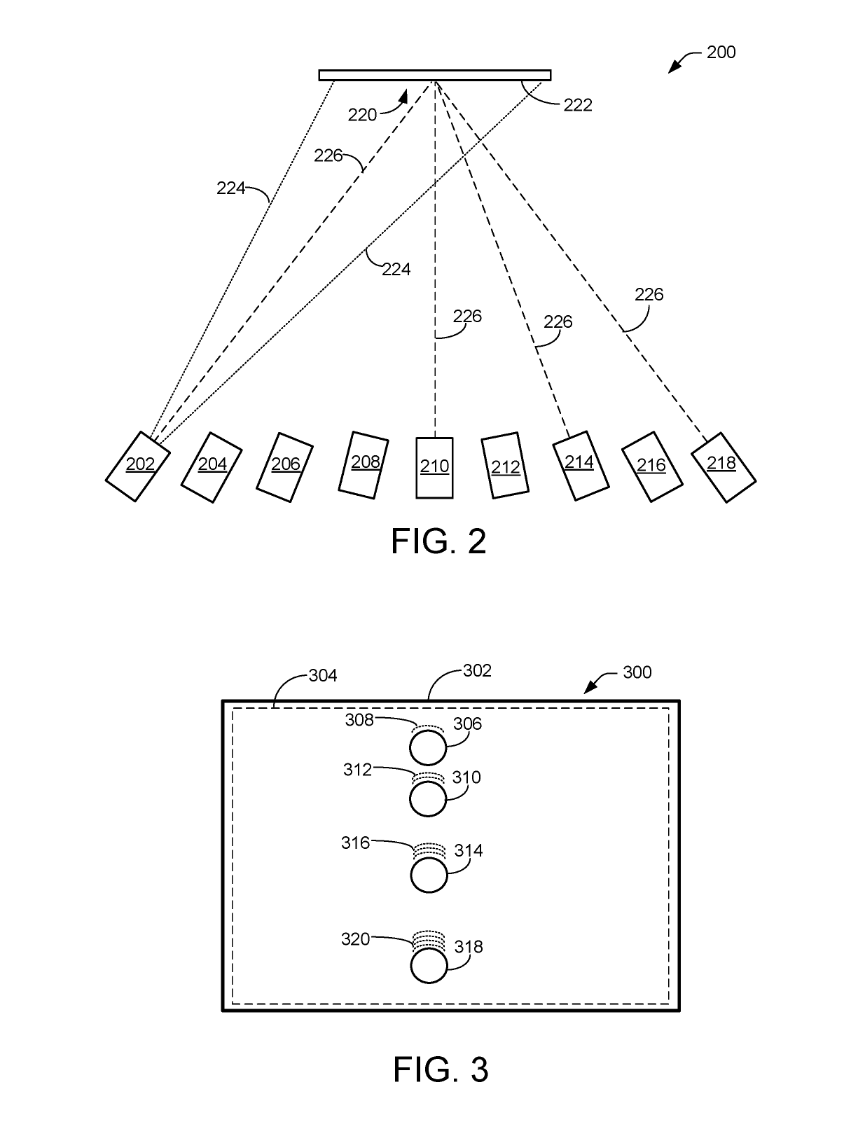

FIG. 2 is a top view of a projection system 200 (sans a view of a controller portion) of slide projectors 202-218 producing an integrated image 220 on a surface 222, according to various examples. Such an integrated image may be a superposition of overlapped images produced by each of slide projectors 202-218. Though FIG. 2 is indicated as being a top view, the view may be considered a side view, bottom view, or of any other direction or orientation, and claimed subject matter is not limited to any particular orientation or configuration of slide projectors 202-218.

For sake of clarity in FIG. 2, only the outline of the projection from slide projector 202 is illustrated and is labelled “224”. Also for sake of clarity, only the axes of projection for slide projectors 202, 210, 214, and 218 are illustrated and are labelled 226.

In some examples, slide projectors that are at angles skewed from the orientation of surface 222 (which need not be planer) may produce images on surface 222 that are geometrically distorted. One type of distortion, in addition to other types, is referred to as keystone distortion. Distortions may be alleviated, if desired, by modifying optical systems in individual slide projectors and/or countering effects of distortions by modifying images of the basis slides. For example, an optical system may be designed to offset angular distortion anticipated for a position/orientation of a particular slide projection. In another example, an image of a basis slide may be judiciously transformed so that a distortion of a projection of the basis slide is less noticeable than would be the case without transforming the basis slide.

As explained in detail below, each of slide projectors 202-218 may be individually controlled by a computer system such as computing device 102, for example. In a particular example, projector controller 116 may vary the intensity of projection of each of the slide projectors by controller the amount of current and/or voltage supplied to light sources in the slide projectors. In some examples, the projection intensity may be varied continuously or discretely ranging from off (e.g., substantially zero light intensity) to fully bright. Thus, for example, projector controller 116 may control slide projector 206 to have a projection intensity of 50% maximum, slide projector 208 to have an projection intensity of 0% (e.g., off or dark), and slide projector 210 to have an projection intensity of 100% maximum. In such a case, the image of a slide in projector 208 would not be visible and would thus not contribute to an integrated image formed by the overlapped images of slide projectors 206, 208, and 210. Moreover, the image of a slide in projector 210 would contribute greatly and generally be dominant in the integrated image. The image of a slide in projector 206 would contribute about half that of the image of a slide in projector 210. Such an estimate of effects of the relative brightnesses of the slide projectors on the integrated image, however, may be more complex if consideration is given to the fact that each of the slides may be different from one another, so effects of projector brightness may only be part of the estimate. For example, in a simplified description, the image of the slide in slide projector 206 may result in a “lighter” (e.g., greater transparency of the slide) than the image of the slide in slide projector 210. Accordingly, regardless of the brightness of the light source of the respective slide projectors, a resultant integrated image may be a convolution of brightnesses of the respective slide projections and the features of the images in each of the slide projectors.

FIG. 3 illustrates an integrated image 300 resulting from four disparate images projected from four slide projectors, such as 208, 210, 212, 214, for example. A simplified example of a ball appearing to fall downward is illustrated. Integrated image 300 comprises a superposition of four images, a first image of a slide in slide projector 208, a second image of a slide in slide projector 210, a third image of a slide in slide projector 212, and a fourth image of a slide in slide projector 214.

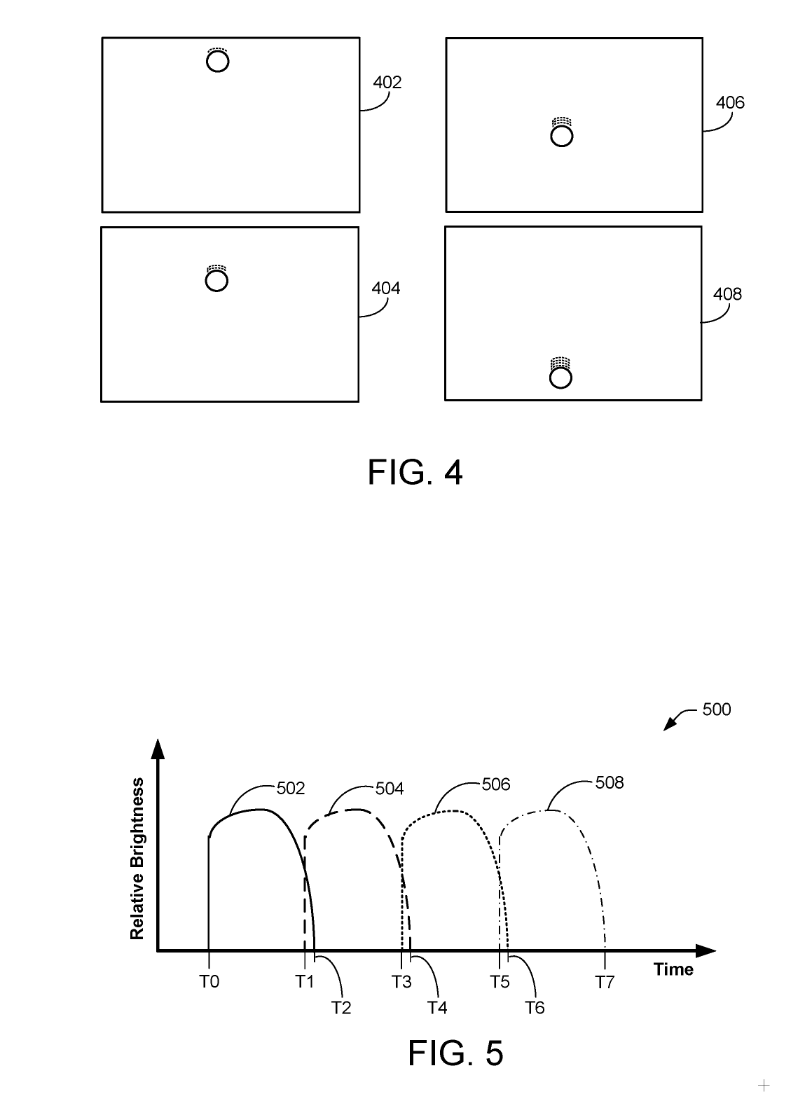

FIG. 4 illustrates the first image 402, the second 404, the third image 406, and the fourth image 408. These images may be referred to as basis images, as described below. Each of the first, second, third, and fourth images are positioned on screen 302 to overlap one another and to substantially encompass the area of the screen, which is illustrated as outline 304. In other words, an outline of the first image corresponds to the outline 304, an outline of the second image corresponds to the outline 304, an outline of the third image corresponds to the outline 304, and an outline of the fourth image corresponds to the outline 304.

The first image comprises the image of ball 306 and action line 308. The second image comprises the image of ball 310 and action lines 312. The third image comprises the image of ball 314 and action lines 316. The fourth image comprises the image of ball 318 and action lines 320.

If all slide projectors 208-214 were illuminated equally, integrated image 300 may appear to a viewer as it appears in the drawing of FIG. 3 (e.g., all ball images and action lines appearing simultaneously). However, the four slides in the respective slide projectors may be projected to give a viewer an illusion of a ball falling downward with increasing speed, for example. This may be accomplished by sequentially illuminating the images.

FIG. 5 illustrates an example time sequence 500 of the relative brightnesses of the slide projectors that are projecting the first, second, third, and fourth images of integrated image 300. Curve 502 represents the brightness of the first slide projector that is projecting the first image onto screen 302, curve 504 represents the brightness of the second slide projector that is projecting the second image onto screen 302, curve 506 represents the brightness of the third slide projector that is projecting the third image onto screen 302, and curve 506 represents the brightness of the fourth slide projector that is projecting the fourth image onto screen 302.

The example time sequence 500 of FIG. 5 illustrates one example of adjusting the relative brightnesses of the projectors so that the ball illustrated in FIG. 3 may appear to drop down the screen. This may be accomplished by illuminating only the first image (e.g., brightness of slide projector 208 high, other slide projectors not illuminated), then illuminating only the second image (e.g., brightness of slide projector 210 high, other slide projectors not illuminated), then illuminating only the third image (e.g., brightness of slide projector 212 high, other slide projectors not illuminated), and then illuminating only the fourth image (e.g., brightness of slide projector 214 high, other slide projectors not illuminated).

In detail, from time T0 to time T2, the first slide projector has a relatively high brightness and the first slide image (e.g., 402) is visible on screen 302 while the brightnesses of the third and fourth slide projectors are substantially zero. In this particular example, the brightness of the second slide projector begins to increase at time T1 before the brightness of the first slide projector is decreased to zero at time T2. This overlap of brightness levels of the first and second projectors may allow for a type of blending of the first and second images (e.g., a fade in of the second image while the first image fades out). Similar overlap may be implemented for the second, third, and fourth slide projectors at times T3-T6, for example. At time T7, the sequence from time T0 may be cyclically repeated. Of course, such a time sequence of brightnesses of the slide projectors (and the effects that are intended to be accomplished) is merely an example, and claimed subject matter is not so limited.

The period of time that the respective slide projectors are illuminated need not be the same for the slide projectors. For example, during the above-described sequence, slide projector 210 may be illuminated for a period that is half as long a period of illumination for slide projector 208.

In some examples, brightnesses of the respective slide projectors may be individually adjusted with periods of milliseconds or shorter. For example, projector control module 116 may adjust brightness of slide projector 208 to have a particular brightness value for a few milliseconds. Subsequently, projector control module 116 may adjust brightness of slide projector 210 to have a particular brightness value for a few milliseconds. Such brightness modulation or adjusting may be applied across the plurality of slide projectors 208-214. In this fashion, an integrated image may be generated and modified on a time scale of milliseconds or shorter (e.g., microsecond scale: LEDs, among other example light sources, may be modulated at such time scales).

In another example, four additional slide projectors may have respective slides that are duplicated of the slides in slide projectors 208-214 except that the color of the ball image may be different. Thus, with eight slide projectors configured in this fashion, a slide projector system may be operated so that the ball appears to fall and change colors while falling. Of course, many other variations are possible, and claimed subject matter is not limited to such examples.

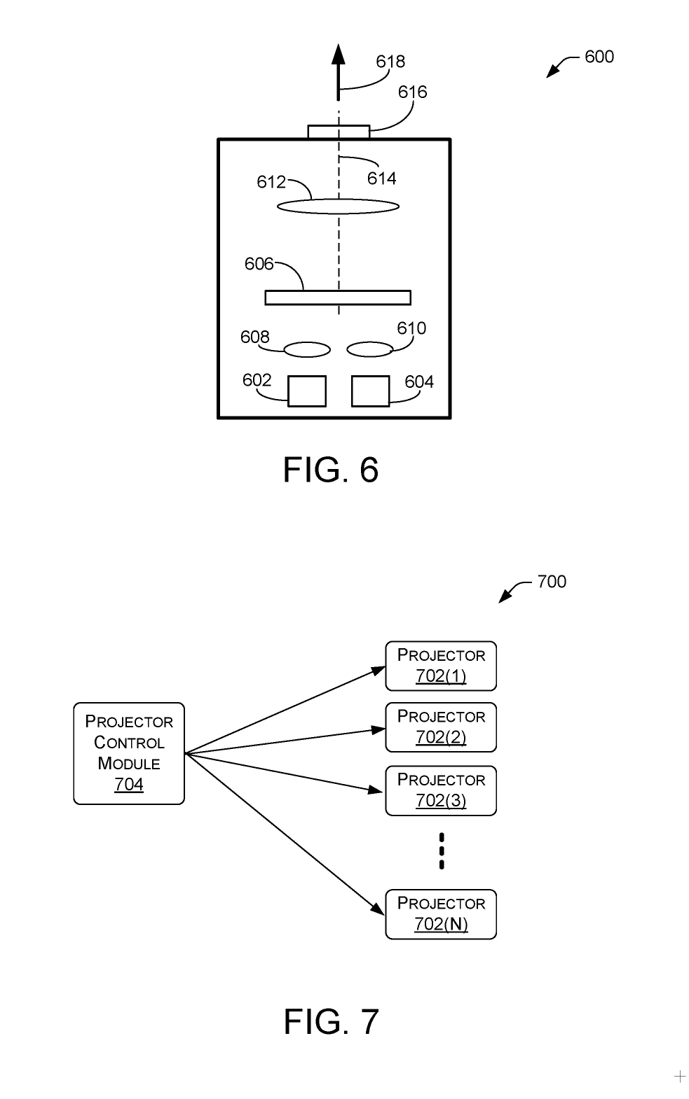

FIG. 6 is a schematic diagram of an example slide projector 600, which may be the same as or similar to any of slide projectors 202-218 illustrated in FIG. 2, for example. Slide projector 600, which may part of a slide projector system, may include any number of light sources 602 and 604 to illuminate a slide 606. Light sources may include light emitting diodes (LEDs) or incandescent lights, just to name some examples. Generally, a single light source may be used, but two or more light sources may allow for different portions of slide 606 to be illuminated independently of one another. Such independent illumination may provide additional degrees of freedom for the slide projector system to produce integrated images. Each light source may be associated with an illumination optical system 608 and 610, respectively, which may provide relatively uniform illumination across the slide (or a portion thereof). In some implementations, slide 606 may be transmissive and comprise a polymer (or other) material having an embedded image. Some examples are negatives (e.g., 35 mm slides or 6×5 color slides) or positive image transparencies. The image included in slide 606 may be an analog image (e.g., not a digitized image) comprising continuous variations in transmissivity across slide 606. In some implementations, slide 606 may be inserted into or removed from slide projector 600 automatically or manually via slots, a carousel system, or other mechanism, just to name a few examples.

An image field produced by illuminating slide 606 may be formed into a projection by image optical system 612. A resulting image may be projected along an optical axis 614 through an aperture or window 616 toward a surface (e.g., 222) in a direction represented by arrow 618.

As mentioned above, each of light sources 602 and 604 may be individually controlled to adjust brightness of the light sources. A controller such as projector controller module 116 may perform such function, for example.

FIG. 7 is a block diagram of a slide projector system 700 of N slide projectors 702(1)-702(N) operated by a projector control module 704, which may be the same as or similar to projector controller module 116 illustrated in FIG. 1, according to various examples. System 700 may include any number N of projectors, each of which may be the same as or similar to slide projectors 202-218 illustrated in FIG. 2, for example.

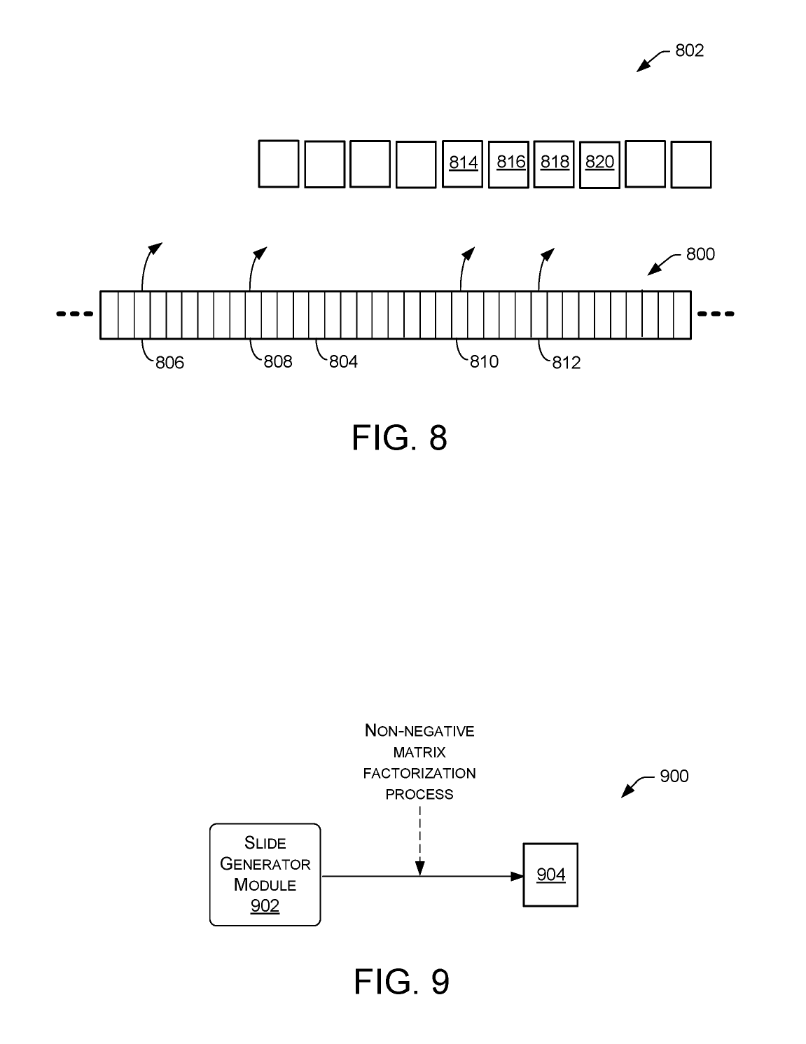

FIG. 8 illustrates a sequence 800 of video frames and a set of basis slides 802 selected from sequence 800, according to various examples. Basis slides 802 may each be placed in a respective slide projector (e.g., slide projectors 202-218 illustrated in FIG. 2) of a slide projector system. In some implementations, basis slides 802 may be selected from sequence 800. In some implementations, image frames selected from sequence 800 may be modified, as described below, and be transformed into basis slides 802. In some examples, basis images may be designed manually (e.g., by hand), and a given video sequence may then be approximated by a linear combination of such basis images (e.g., similar to that of PCA or non-negative matrix factorization).

Sequence 800 may be, for example, a full video or a portion of a video that includes thousands of discrete image frames 804 (digital or analog). Some videos may comprise about 30 frames per second of video.

In some examples, a non-negative matrix factorization algorithm may be used to create basis images 802 from image frames selected from sequence 800. The basis images may be normalized so that they can be printed, and the brightness of the projectors having particular basis images may be adjusted accordingly during operation of the projection system by projector control module 116, for example. Any of a number of other image processing techniques may be used to create basis images.

In some examples, an integrated image I may be represented as a linear combination of basis images Iᵢ, as in Equation 1.

I({s})=Σᵢ, (αᵢIᵢ) [1]

I ({s}) represents the intensity field of an integrated image resulting from a superposition of images from a number n of projectors, wherein the summation over index i is performed over n terms. {s} indicates a dependency of I on the set {s} of basis slides that are in the n projectors. The individual terms αᵢIᵢ represent the intensity field contribution to the integrated image for the ith slide projector. The coefficients αᵢ represent relative image brightness for the ith slide projector.

In a particular illustrative example, video sequence 800 may include image frames 806, 808, 810, and 812 that are selected for forming basis images 802. Such selection may result from any of a number of considerations (e.g., how effectively the selected images can be used for a desired integrated image). In some examples, principal component analysis (PCA) may be involved in such selection. PCA is generally a statistical procedure that uses an orthogonal transformation to convert a set of observations of possibly correlated variables of an image frame into a set of values of linearly uncorrelated variables called principal components. These principal components may be normalized and printed into slides. To improve results of PCA, the principal components may be constrained to have no negative values by using a process called non-negative PCA. In some implementations, basis images need not originate from a video sequence.

The selected image frames 806, 808, 810, and 812 may be operated on by any of a number of image processing techniques, including, for example, non-negative matrix factorization. In some implementations, an application, such as slide generator module 118 illustrated in FIG. 1, may be used to perform image processing techniques and generation of basis slides from image frames of a video sequence or from other types of images. In the illustrated example, slide generator module 118 may transform or modify image frame 806 into basis image 814, transform or modify image frame 808 into basis image 816, transform or modify image frame 810 into basis image 818, and transform or modify image frame 812 into basis image 820. Basis images 814-620, among additional basis images, may be placed into respective slide projectors and projected onto a surface to form an integrated image based, at least in part, on the basis images and the relative projection brightnesses of the respective slide projectors. Such relative projection brightnesses may have a time dependency that may lead to the integrated image changing over time, and appearing as a video or other visual entity. In some examples, an integrated image(s) (e.g., a video) may be generated so that the integrated image(s) are “outside” the input video sequence. Such generation may be performed by operating beyond coefficient values (e.g., alpha values) observed in the input data. Also, multiple sequences of input may be provided that are then approximated by the same fixed number of basis images. Additionally, a video sequence (e.g., the integrated image(s)) may be “played back” in an order or speed that was not observed in the input sequence. In other words, speed and/or order of a sequence of projecting images of respective slide projectors (e.g., 202-218) may be varied independently of an order of the input sequence of slides.

FIG. 9 is a block diagram illustrating a system 900 that includes a slide generator module 902 and a slide 904 created using any of a number of image processing techniques performed by slide generator module 902, according to various examples. In some implementations, slide generator module 902 may be the same as or similar to slide generator module 118, illustrated in FIG. 1. Processes performed by slide generator module 902 may be the same as or similar to processes described for FIG. 8, for example. In some implementations, processes performed by projector control module 116 and slide generator module 118 are performed at different times. In still other implementations, processes performed by a slide generator module 902 may be performed by computer system that is different from a computer system that operates projector control module 116.

In some examples, slide generator module 902 may involve a process of non-negative matrix factorization to modify or transform image frames into basis images. For example, such non-negative matrix factorization may modify or transform an image frame such as 808 into a slide 904, which may be a basis image, such as 816 illustrated in FIG. 8

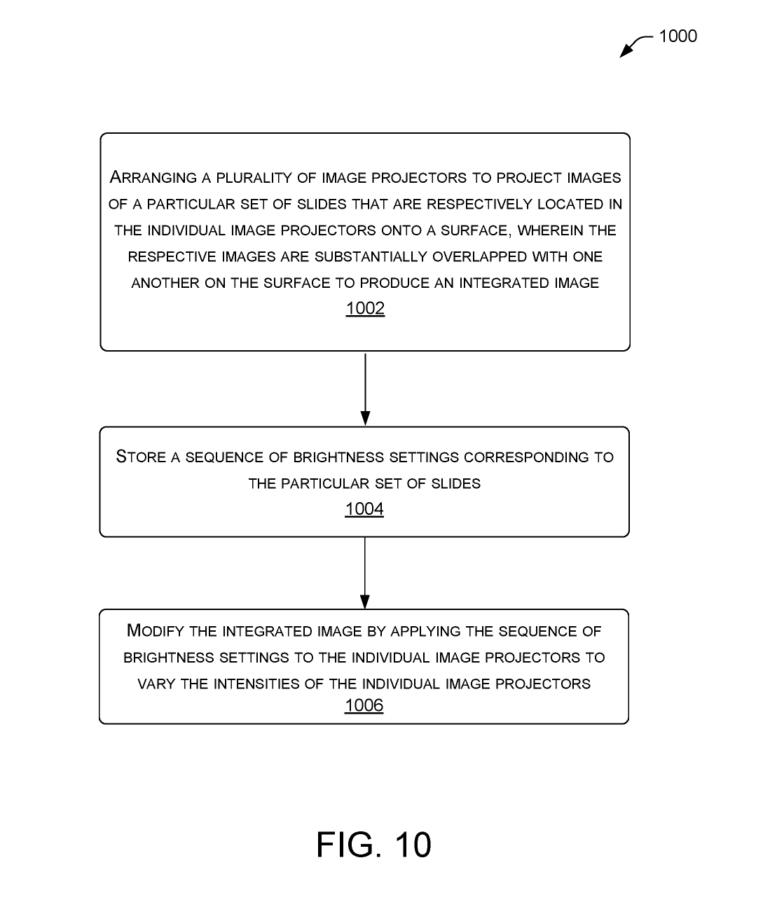

FIG. 10 is a flow diagram illustrating a process for operating a system of slide projectors, according to some examples. Such a system may be the same as or similar to, for example, system 200. Process 1000 may be performed, in part, by a processor such as processor 104, for example.

At block 1002, a plurality of image projectors may be arranged to project images of a particular set of slides that are respectively located in the individual image projectors onto a surface. The respective images may be substantially overlapped with one another on the surface to produce an integrated image on the surface. For example, a first slide of the set of slides may be located in a first image projector, a second slide of the set of slides may be located in a second image projector, a third slide of the set of slides may be located in a third image projector, and so on. Each of the slides of the set of slides may be different from one another (e.g., have different images thereon). The number of image projectors may be several, 5, 10, or a dozen or so and claimed subject matter is not so limited.

At block 1004, a sequence of brightness settings corresponding to the particular set of slides may be stored in a memory, such as 108. For example, such a sequence of brightness settings may define how brightnesses of each of the image projectors may be changed over time to produce an integrated imaged. Time sequence 500 illustrated in FIG. 5 may result from a sequence of brightness settings, for example.

At block 1006, the processor may modify the integrated image by applying the sequence of brightness settings to the individual image projectors to vary the intensity of the individual image projectors.

The flows of operations illustrated in FIG. 10 are illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor to perform the recited operations. In the context of hardware, the blocks may represent one or more circuits (e.g., FPGAs, application specific integrated circuits—ASICs, etc.) configured to execute the recited operations.

Any process descriptions, variables, or blocks in the flows of operations illustrated in FIG. 10 may represent modules, segments, or portions of code that include one or more executable instructions for implementing specific logical functions or variables in the process.

### EXAMPLE CLAUSES

A. A system comprising: a plurality of image projectors, wherein individual ones of the image projectors include a light source for projecting a physical image contained in the image projector; one or more processing units communicatively connected to the individual ones of the image projectors; and computer-readable media accessible by the one or more processing units and comprising: memory to store a sequence of brightness settings for the respective individual ones of the image projectors; and a projector control module to modify intensities of the light sources of the individual ones of the plurality of image projectors based, at least in part, on the sequence of brightness settings.

A. The system as paragraph A recites, wherein the image projectors are slide projectors and the physical image is a slide.

C. The system as paragraph B recites, wherein at least one of the light sources comprises an incandescent light.

D. The system as paragraph A recites, wherein the projector control module is configured to control color of the light source of the individual ones of the plurality of image projectors.

E. The system as paragraph D recites, wherein the light source of the individual ones of the plurality of image projectors comprises two or more individual light sources that are individually modifiable by the projector control module.

F. The system as paragraph A recites, further comprising the physical images contained in the plurality of image projectors, wherein the computer-readable media accessible by the one or more processing units further comprises a slide generator module to produce the physical images from image frames of a single video sequence.

G. The system as paragraph A recites, further comprising the physical images contained in the plurality of image projectors recites, wherein the computer-readable media accessible by the one or more processing units further comprises a slide generator module to produce the physical images using non-negative matrix factorization.

H. The system as paragraph A recites, further comprising the physical images contained in the plurality of image projectors, wherein the physical images are non-pixelated analog images.

I. The system as paragraph A recites, wherein the plurality of image projectors are oriented to project their respective images onto a surface so that the respective images substantially overlap with one another on the surface and produce an integrated image.

J. A method for operating a plurality of image projectors that project images of a particular set of slides that are respectively located in the individual image projectors onto a surface, the respective images substantially overlapped with one another on the surface to produce an integrated image, the method comprising: storing a sequence of brightness settings corresponding to the particular set of slides; and modifying the integrated image by applying the sequence of brightness settings to the individual image projectors to vary the intensity of the individual image projectors.

K. The method as paragraph J recites, further comprising: providing the individual projectors with respective physical images.

L. The method as paragraph K recites, further comprising: before providing the individual projectors with the respective physical image, producing the respective physical images using non-negative matrix factorization.

M. The method as paragraph K recites, further comprising deriving the respective physical images from a single video sequence.

N. The method as paragraph J recites, wherein the image projectors are slide projectors configured to project a non-pixelated image.

O. The method as paragraph J recites, further comprising: modifying the integrated image by providing control signals to the individual image projectors to vary the color of the individual image projectors.

P. An apparatus comprising: image projectors individually oriented to project their respective images onto a surface so that the respective images substantially overlap with one another on the surface and produce an integrated image; and a controller connected to the individual image projectors to vary the intensity of a respective light source in the individual image projectors, wherein the image projectors are configured to produce analog, non-pixelated images.

Q. The apparatus as paragraph P recites, further comprising a respective physical analog image in the individual image projectors.

R. The apparatus as paragraph Q recites, wherein the integrated image is based, at least in part, on the respective physical analog images and brightness of the respective light sources in the individual image projectors.

S. The apparatus as paragraph Q recites, wherein the respective physical analog images comprise images generated by non-negative matrix factorization.

T. The apparatus as paragraph P recites, wherein the respective physical analog images comprise images generated using principal component analysis (PCA).

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “may” or “may,” unless specifically stated otherwise, are understood within the context to present that certain examples include, while other examples do not include, certain features, variables and/or steps. Thus, such conditional language is not generally intended to imply that certain features, variables and/or steps are in any way required for one or more examples or that one or more examples necessarily include logic for deciding, with or without user input or prompting, whether certain features, variables and/or steps are included or are to be performed in any particular example.

Conjunctive language such as the phrase “at least one of X, Y or Z,” unless specifically stated otherwise, is to be understood to present that an item, term, etc. may be either X, Y, or Z, or a combination thereof.

Any process descriptions, variables or blocks in the flow diagrams described herein and/or depicted in the attached figures should be understood as potentially representing modules, segments, or portions of code that include one or more executable instructions for implementing specific logical functions or variables in the routine. Alternate implementations are included within the scope of the examples described herein in which variables or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the variables of which are to be understood as being among other acceptable examples. All such modifications and variations are intended to be included herein within the scope of this disclosure and protected by the following claims.

1. A system comprising:
a plurality of image projectors, wherein individual ones of the image projectors include a light source for projecting a single, non-pixelated physical image contained in the image projector;
one or more processing units communicatively connected to the individual ones of the image projectors; and
computer-readable media accessible by the one or more processing units and comprising:
memory to store a sequence of brightness settings for the respective individual ones of the image projectors, wherein the brightness settings are based, at least in part, on the single, non-pixelated physical images respectively contained in individual ones of the plurality of image projectors; and
a projector control module to modify intensities of the light sources of the individual ones of the plurality of image projectors based, at least in part, on the sequence of brightness settings.

2. The system of claim 1, wherein the image projectors are slide projectors and the physical image is a slide.

3. The system of claim 2, wherein at least one of the light sources comprises an incandescent light.

4. The system of claim 1, wherein the projector control module is configured to control color of the light source of the individual ones of the plurality of image projectors.

5. The system of claim 4, wherein the light source of the individual ones of the plurality of image projectors comprises two or more individual light sources that are individually modifiable by the projector control module.

6. The system of claim 1, further comprising the physical images contained in the plurality of image projectors, wherein the computer-readable media accessible by the one or more processing units further comprises a slide generator module to produce the physical images from image frames of a single video sequence.

7. The system of claim 1, further comprising the physical images contained in the plurality of image projectors, wherein the computer-readable media accessible by the one or more processing units further comprises a slide generator module to produce the physical images using non-negative matrix factorization.

8. The system of claim 1, further comprising the physical images contained in the plurality of image projectors, wherein the physical images are non-pixelated analog images.

9. The system of claim 1, wherein the plurality of image projectors are oriented to project their respective images onto a surface so that the respective images substantially overlap with one another on the surface and produce an integrated image.

10. A method for operating a plurality of image projectors that project respective images onto a surface, the respective images substantially overlapped with one another on the surface to produce an integrated image, the method comprising:
placing a single, non-pixelated physical image into individual ones of the image projectors;
storing a sequence of brightness settings corresponding to the single, non-pixelated physical images respectively in the image projectors; and
modifying the integrated image by applying the sequence of brightness settings to the individual image projectors to vary the intensity of the individual image projectors.

11. The method of claim 10, wherein the single, non-pixelated physical images comprise analog slides.

12. The method of claim 10, further comprising:
before placing the single, non-pixelated physical image into individual ones of the image projectors, producing the respective single, non-pixelated physical images using non-negative matrix factorization.

13. The method of claim 10, further comprising deriving the respective single, non-pixelated physical images from a single video sequence.

14. The method of claim 10, wherein the image projectors are slide projectors.

15. The method of claim 10, further comprising:
modifying the integrated image by providing control signals to the individual image projectors to vary the color of the individual image projectors.

16. An apparatus comprising:
image projectors individually oriented to project their respective images onto a surface so that the respective images substantially overlap with one another on the surface and produce an integrated image;
a single, non-pixelated physical image in individual ones of the image projectors; and
a controller connected to the individual image projectors to vary the intensity of a respective light source in the individual image projectors based, at least in part, on the single, non-pixelated physical images respectively contained in individual ones of the image projectors, wherein the image projectors are configured to produce analog, non-pixelated images.

17. The apparatus of claim 16, wherein the single, non-pixelated physical images comprise analog slides.

18. The apparatus of claim 16, wherein the integrated image is based, at least in part, on the respective single, non-pixelated physical images and intensity of the respective light sources in the individual image projectors.

19. The apparatus of claim 16, wherein the respective single, non-pixelated physical images comprise images generated by non-negative matrix factorization.

20. The apparatus of claim 16, wherein the respective single, non-pixelated physical images comprise images generated using principal component analysis (PCA).
